(19) United States
(12) Patent Application Publication
(10) Pub. No.: US 2026/0236136 A1
(43) Pub. Date: Aug. 13, 2026

(54) GENERATION OF INSTRUCTIONAL INTERACTIONS FOR ADAPTIVE TRAINING IN VIRTUAL SESSION

(71) Applicant: International Business Machines Corporation, Armonk, NY (US)

(72) Inventors: Ke Huan Yin, Ningbo (CN); Li Wang, Shanghai (CN); Jie Jiang, Ningbo (CN); Wen Juan Nie, Ningbo (CN); Chen Guang Liu, BEIJING (CN)

(21) Appl. No.: 19/052,327

(22) Filed: Feb. 13, 2025

(51) Int. Cl. G06F 3/04815; G09B 5/06

(52) U.S. Cl. CPC G06F 3/04815; G09B 5/06

(57) ABSTRACT

Generation of instructional interactions in a virtual session includes receiving first environment data associated with a first user device and a second environment data associated with a second user device. The first environment data and the second environment data are analyzed to determine the first environment is different from the second environment data. A first set of instructional interactions associated with at least one of the first user device or a first entity is detected. A second set of instructional interactions associated with at least one of the second user device or a second entity is generated based on the application of the language model on the first set of instructional interactions, the first environment data, and the second environment data. The generated second set of instructional interactions is outputted.

### BACKGROUND

The disclosure relates to data processing and more particularly, to generation of instructional interactions in a virtual session.

Advancements in three-dimensional (3D) computer graphics have transformed the landscape of education by enabling the creation of virtual classrooms that offer interactive and immersive learning experiences. This environment allows instructors that may be teachers to present complex concepts and demonstrations in a visually engaging manner, facilitating a deeper understanding of content shared in the virtual classrooms. In virtual classrooms, students may actively participate by replicating demonstrations or exercises on their own devices, which enhances their engagement and retention of knowledge. The integration of 3D graphics into educational settings supports diverse learning styles and encourages collaboration among students, fostering a sense of community even in remote learning scenarios. This approach not only makes learning more accessible but also prepares students for a future where digital literacy and technological proficiency are paramount.

### SUMMARY

In various embodiments of the disclosure, a computer-implemented method for generating instructional interactions in a virtual session is described. The computer-implemented method includes receiving, by a computer, first environment data associated with a first user device and second environment data associated with a second user device. The computer-implemented method further includes analyzing, by the computer, the first environment data and the second environment data. The computer-implemented method further includes determining, by the computer, the first environment data is different from the second environment data based on the analysis of the first environment data and the second environment data. The computer-implemented method further includes detecting, by the computer, a first set of instructional interactions associated with at least one of the first user device or a first entity based on the determination of the first environment data being different from the second environment data. The first entity is associated with the first user device. The computer-implemented method further includes applying, by the computer, a language model on the first set of instructional interactions, the first environment data, and the second environment data based on the detection of the first set of instructional interactions. The computer-implemented method includes generating, by the computer, a second set of instructional interactions associated with at least one of the second user device or a second entity based on the application of the language model on the first set of instructional interactions, the first environment data, and the second environment data. The second entity is associated with the second user device. The computer-implemented method includes outputting, by the computer, the generated second set of instructional interactions.

In various embodiments of the disclosure, a computer system for the generation of instructional interactions in a virtual session is described. The computer system includes a processor set, a computer-readable storage media, and program instructions that are stored on the one or more computer-readable storage media. The program instructions are executable by the processor set to cause the processor set to receive first environment data associated with a first user device and second environment data associated with a second user device. The program instructions further cause the processor set to analyze the first environment data and the second environment data. The program instructions further cause the processor set to determine the first environment data is different from the second environment data based on the analysis of the first environment data and the second environment data. The program instructions further cause the processor set to detect a first set of instructional interactions associated with at least one of the first user device or a first entity based on the determination of the first environment data being different from the second environment data. The first entity is associated with the first user device. The program instructions further cause the processor set to apply a language model on the first set of instructional interactions, the first environment data, and the second environment data based on the detection of the first set of instructional interactions. The program instructions further cause the processor set to generate a second set of instructional interactions associated with at least one of the second user device or a second entity based on the application of the language model on the first set of instructional interactions, the first environment data, and the second environment data. The second entity is associated with the second user device. The program instructions further cause the processor set to output the generated second set of instructional interactions.

In various embodiments of the disclosure, a computer program product for generation of instructional interactions in a virtual session is described. The computer program product includes a computer-readable storage media having program instructions stored on the computer-readable storage media to perform operations. The operations include receiving first environment data associated with a first user device and second environment data associated with a second user device. The operations further include analyzing the first environment data and the second environment data. The operations further include determining whether the first environment data is different from the second environment data based on the analysis of the first environment data and the second environment data. The operations further include detecting a first set of instructional interactions associated with at least one of the first user device or a first entity based on the determination of the first environment data being different from the second environment data. The first entity is associated with the first user device. The operations further include applying a language model on the first set of instructional interactions, the first environment data, and the second environment data based on the detection of the first set of instructional interactions. The operations further include generating a second set of instructional interactions associated with at least one of the second user device or a second entity based on the application of the language model on the first set of instructional interactions, the first environment data, and the second environment data. The second entity is associated with the second user device. The operations include outputting the generated second set of instructional interactions.

Additional technical features and benefits are realized through the process of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of instructional interactions in a virtual session, in accordance with an embodiment of the disclosure;

FIG. 2 is a diagram that illustrates an environment for the generation of the instructional interactions in the virtual sessions, in accordance with an embodiment of the disclosure;

FIG. 3 is a diagram that illustrates one or more operations performed by a system for the generation of the instructional interactions in the virtual session, in accordance with an embodiment of the disclosure;

FIG. 4 is a diagram that illustrates a flowchart that depicts generation of a third set of instructional interactions based on an analysis of a second set of instructional interactions and a set of actions, in accordance with an embodiment of the disclosure;

FIG. 5 is a diagram that illustrates exemplary operations for the generation of the instructional interactions in the virtual session, in accordance with an embodiment of the disclosure;

FIG. 6A is a diagram that illustrates a first user interface associated with the generation of the instructional interactions in the virtual session, in accordance with an embodiment of the disclosure;

FIG. 6B is a diagram that illustrates a second user interface associated with the generation of the instructional interactions in the virtual session, in accordance with an embodiment of the disclosure;

FIG. 6C is a diagram that illustrates a third user interface associated with the generation of the instructional interactions in the virtual session, according to one embodiment; and

FIG. 7 is a diagram that illustrates a flowchart of an exemplary method for the generation of the instructional interactions in the virtual session, in accordance with an embodiment of the disclosure.

### DETAILED DESCRIPTION

In virtual classrooms, students are often required to replicate the instructor's actions on their own devices, which may vary in terms of system configuration, software versions, or operating systems. These variations create challenges for instructors, as each student may need different steps to achieve the same outcome making it difficult to provide uniform guidance. Traditional solutions offer engagement through overlays and instructions but do not deliver real-time, customized guidance that adjusts to each student's specific practice environment. Platforms that standardize practice environments also fall short, as they restrict students from using their existing system setups, creating impractical situations for diverse software versions and operating systems.

The proposed system provides an intelligent method that adapts instructional guidance to each student's specific workstation environment in real-time. Unlike traditional methods, which either require uniform software setups or fail to provide personalized instruction, this system discloses adaptive and step-by-step guidance based on the student's computer system. Such real-time feedback is also provided to ensure students follow the correct steps and allow them to achieve the expected results without needing to alter their workstations.

One advantage of the proposed system is that instructors no longer need to explain equivalent steps for different practice environments. Additionally, students do not have to spend time setting up or changing their workstations to match the instructor's system. An additional advantage is that the customized guidance and instructions ensure students using any system can follow along confidently. Furthermore, real-time feedback helps students stay on track and enhances their ability to achieve the expected results without missing any crucial steps.

The proposed system delivers tailored guidance based on real-time teacher operations, specifically targeting each student's workstation environment. Unlike prior solutions that adjust training exercises according to student proficiency levels, the proposed system focuses on replicating the teacher's operations and dynamically aligning the student's workstation to these demonstrations. This real-time adaptation offers a seamless learning experience without the need for manual intervention, such as code embedding or configuration adjustments.

Further, the proposed system dynamically responds to the teacher's input without the requirement for advanced deployment or pre-configuration of any software or suite of software. By avoiding the complexities of manual setup and the need to tailor exercises based on student skill levels, this proposed system provides a highly efficient and flexible learning environment. The use of real-time adaptability ensures that each student can perform the exercises in alignment with the teacher's operations, regardless of variations in the hardware or software setup of individual workstations. The technical solution of the proposed system improves the scalability of the training environment, as the proposed system can accommodate various training scenarios without additional configuration. Further, the proposed system also enhances usability by eliminating the need for prior customization of student exercises and enables a more intuitive and interactive learning experience.

According to an embodiment of the disclosure, a computer-implemented method for generating instructional interactions in a virtual session is described. The computer-implemented method includes receiving, by a computer, first environment data associated with a first user device and second environment data associated with a second user device. The computer-implemented method further includes analyzing, by the computer, the first environment data and the second environment data. The computer-implemented method further includes determining, by the computer, the first environment data is different from the second environment data based on the analysis of the first environment data and the second environment data. The computer-implemented method further includes detecting, by the computer, a first set of instructional interactions associated with at least one of the first user device or a first entity based on the determination of the first environment data being different from the second environment data. The first entity is associated with the first user device. The computer-implemented method further includes applying, by the computer, a language model on the first set of instructional interactions, the first environment data, and the second environment data based on the detection of the first set of instructional interactions. The computer-implemented method includes generating, by the computer, a second set of instructional interactions associated with at least one of the second user device or a second entity based on the application of the language model on the first set of instructional interactions, the first environment data, and the second environment data. The second entity is associated with the second user device. The computer-implemented method includes outputting, by the computer, the generated second set of instructional interactions.

In various embodiments of the disclosure, the computer-implemented method further includes detecting, by the computer, a set of actions associated with at least one of the second user device or the second entity based on the output of the second set of instructional interactions. The computer-implemented method further includes analyzing, by the computer, the first set of instructional interactions and the set of actions. The computer-implemented method further includes determining, by the computer, the first set of instructional interactions is different from the set of actions based on the analysis of the first set of instructional interactions and the set of actions. The computer-implemented method further includes applying, by the computer, the language model on the set of actions based on the determination that the first set of instructional interactions is different from the set of actions. The computer-implemented method further includes generating, by the computer, a third set of instructional interactions associated with at least one of the second user device or the second entity based on the application of the language model on the set of actions. The computer-implemented method further includes outputting, by the computer, the generated third set of instructional interactions.

In various embodiments of the disclosure, the third set of instructional interactions is customized for at least one of the second user device or the second entity based on the determination that the first set of instructional interactions is different from the set of actions.

In various embodiments of the disclosure, the computer-implemented method further includes detecting, by the computer a set of actions associated with the at least one of the second user device or the second entity based on the output of the second set of instructional interactions. The computer-implemented method further includes analyzing, by the computer, the first set of instructional interactions and the set of actions. The computer-implemented method further includes determining, by the computer, the first set of instructional interactions is similar to the set of actions based on the analysis of the first set of instructional interactions and the set of actions. The computer-implemented method further includes outputting, by the computer, a confirmation message on at least one of the first user device or the second user device. The confirmation message is indicative of an execution of the second set of instructional interactions on the second user device.

In various embodiments of the disclosure, the computer-implemented method further includes modifying, by the computer, the first set of instructional interactions associated with at least one of the first user device or the first entity to remove one or more redundant instructional interactions in the first set of instructional interactions. The computer-implemented method further includes generating, by the computer, the second set of instructional interactions associated with the at least one of the second user device or the second entity based on the modification of the first set of instructional interactions.

In various embodiments of the disclosure, the computer-implemented method further includes retrieving, by the computer, a set of applications based on the analysis of the first environment data and the second environment data. The set of applications is associated with a first application installed on the first user device. The computer-implemented method further includes generating, by the computer, a set of instructions associated with the usage of at least one application of the set of applications. The computer-implemented method further includes outputting, by the computer, the generated set of instructions.

In various embodiments of the disclosure, the computer-implemented method further includes converting, by the computer, the first set of instructional interactions into a first textual description, The first textual description is in a text format. The computer-implemented method further includes applying, by the computer, the language model on the first textual description, the first environment data, and the second environment data.

In various embodiments of the disclosure, the first environment data includes at least one of identifier data associated with the first user device, operating system data associated with the first user device, or application data associated with the first user device.

In various embodiments of the disclosure, the computer-implemented method further includes generating, by the computer, the first set of instructional interactions and the second set of instructional interactions in a multimodal format.

In various embodiments of the disclosure, the first set of instructional interactions and the second set of instructional interactions include at least one of one or more textual descriptions, one or more audio instructions, and one or more visual cues.

In various embodiments of the disclosure, a computer system for the generation of instructional interactions in a virtual session is described. The computer system includes a processor set, a computer-readable storage media, and program instructions that are stored on the one or more computer-readable storage media. The program instructions are executable by the processor set to cause the processor set to receive first environment data associated with a first user device and second environment data associated with a second user device. The program instructions further cause the processor set to analyze the first environment data and the second environment data. The program instructions further cause the processor set to determine the first environment data is different from the second environment data based on the analysis of the first environment data and the second environment data. The program instructions further cause the processor set to detect a first set of instructional interactions associated with at least one of the first user device or a first entity based on the determination of the first environment data being different from the second environment data. The first entity is associated with the first user device. The program instructions further cause the processor set to apply a language model on the first set of instructional interactions, the first environment data, and the second environment data based on the detection of the first set of instructional interactions. The program instructions further cause the processor set to generate a second set of instructional interactions associated with at least one of the second user device or a second entity based on the application of the language model on the first set of instructional interactions, the first environment data, and the second environment data. The second entity is associated with the second user device. The program instructions further cause the processor set to output the generated second set of instructional interactions.

In various embodiments of the disclosure, the program instructions further cause the processor set to detect a set of actions associated with at least one of the second user device or the second entity based on the output of the second set of instructional interactions. The program instructions further cause the processor set to analyze the first set of instructional interactions and the set of actions. The program instructions further cause the processor set to determine the first set of instructional interactions is different from the set of actions based on the analysis of the first set of instructional interactions and the set of actions. The program instructions further cause the processor set to apply the language model on the set of actions based on the determination that the first set of instructional interactions is different from the set of actions. The program instructions further cause the processor set to generate a third set of instructional interactions associated with the at least one of the second user device or the second entity based on the application of the language model on the set of actions. The program instructions further cause the processor set to output the generated third set of instructional interactions.

In various embodiments of the disclosure, the third set of instructional interactions is customized for at least one of the second user device or the second entity based on the determination that the first set of instructional interactions is different from the set of actions.

In various embodiments of the disclosure, the program instructions further cause the processor set to detect a set of actions associated with at least one of the second user device or the second entity based on the output of the second set of instructional interactions. The program instructions further cause the processor set to analyze the first set of instructional interactions and the set of actions. The program instructions further cause the processor set to determine the first set of instructional interactions is similar to the set of actions based on the analysis of the first set of instructional interactions and the set of actions. The program instructions further cause the processor set to output a confirmation message on at least one of the first user device or the second user device. The confirmation message is indicative of an execution of the second set of instructional interactions on the second user device.

In various embodiments of the disclosure, the program instructions further cause the processor set to modify the first set of instructional interactions associated with the at least one of the first user device or the first entity to remove one or more redundant instructional interactions in the first set of instructional interactions. The program instructions further cause the processor set to generate the second set of instructional interactions associated with the at least one of the second user device or the second entity based on the modification of the first set of instructional interactions.

In various embodiments of the disclosure, the program instructions further cause the processor set to retrieve a set of applications based on the analysis of the first environment data and the second environment data. The set of applications is associated with a first application installed on the first user device. The program instructions further cause the processor set to generate a set of instructions associated with a usage of at least one application of the set of applications. The program instructions further cause the processor set to output the generated set of instructions.

In various embodiments of the disclosure, the program instructions further cause the processor set to convert the first set of instructional interactions into a first textual description. The first textual description is in a text format. The program instructions further cause the processor set to apply the language model to the first textual description, the first environment data, and the second environment data.

In various embodiments of the disclosure, the first environment data includes at least one of identifier data associated with the first user device, operating system data associated with the first user device, or application data associated with the first user device.

In various embodiments of the disclosure, the program instructions further cause the processor set to generate the first set of instructional interactions and the second set of instructional interactions in a multimodal format. The first set of instructional interactions and the second set of instructional interactions include at least one of one or more textual descriptions, one or more audio instructions, and one or more visual cues.

In various embodiments of the disclosure, a computer program product for the generation of instructional interactions in a virtual session is described. The computer program product includes a computer-readable storage media having program instructions stored on the computer-readable storage media to perform operations. The operations include receiving first environment data associated with a first user device and second environment data associated with a second user device. The operations further include analyzing the first environment data and the second environment data. The operations further include determining whether the first environment data is different from the second environment data based on the analysis of the first environment data and the second environment data. The operations further include detecting a first set of instructional interactions associated with at least one of the first user device or a first entity based on the determination of the first environment data being different from the second environment data. The first entity is associated with the first user device. The operations further include applying a language model on the first set of instructional interactions, the first environment data, and the second environment data based on the detection of the first set of instructional interactions. The operations further include generating a second set of instructional interactions associated with at least one of the second user device or a second entity based on the application of the language model on the first set of instructional interactions, the first environment data, and the second environment data. The second entity is associated with the second user device. The operations include outputting the generated second set of instructional interactions.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

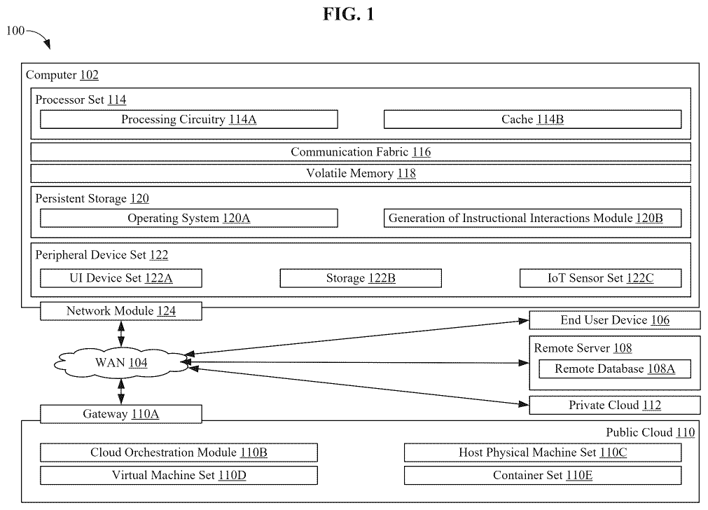

FIG. 1 is a diagram that illustrates a computing environment for the generation of instructional interactions in a virtual session, in accordance with an embodiment of the disclosure. With reference to FIG. 1, there is shown a computing environment 100 that contains an example of an environment for the execution of at least some of the computer code involved in performing the disclosed methods, such as a generation of instructional interactions module 120B. In addition to the generation of instructional interactions module 120B, computing environment 100 includes, for example, a computer 102, a wide area network (WAN) 104, an end-user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the generation of instructional interactions module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computers 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the other storage media discussed below. The program instructions, and associated data, are accessed by the processor set 114 to control and direct the performance of the disclosed methods. In computing environment 100, at least some of the instructions for performing the disclosed methods may be stored in the dynamic modification of the generation of instructional interactions module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the generation of instructional interactions module 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. Gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

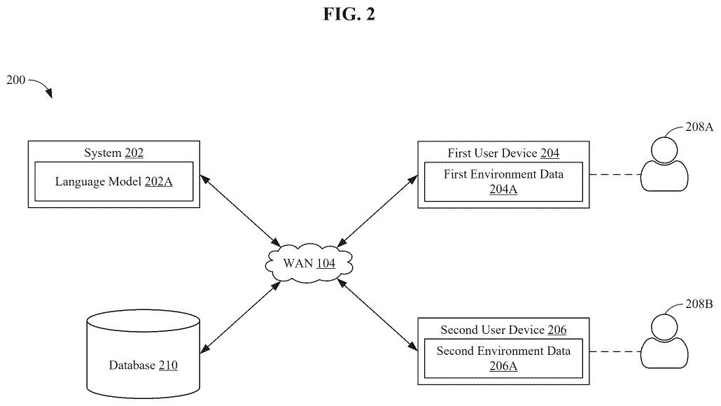

FIG. 2 is a diagram that illustrates an environment for the generation of instructional interactions in virtual sessions, in accordance with an embodiment of the disclosure. FIG. 2 is explained in conjunction with elements from FIG. 1. With reference to FIG. 2, there is shown a diagram of a network environment 200. The network environment 200 includes a computer system (hereinafter referred to as system 202), a first user device 204, and a second user device 206. The system 202 further includes a language model 202A. There is further shown a database 210. The network environment 200 further includes a first entity 208A associated with the first user device 204 and a second entity 208B associated with the second user device 206. The network environment 200 further includes the WAN 104 of FIG. 1. In an embodiment of the disclosure, the first user device 204 and the second user device 206 may be an exemplary embodiment of the EUD 106. Similarly, the system 202 may be an embodiment of the computer 102 in FIG. 1.

The system 202 may include suitable logic, circuitry, interfaces, and/or code that may be configured for the generation of instructional interactions. The system 202 is configured to establish a virtual environment between the first user device 204 and the second user device 206. The system 202 is configured to receive the first environment data 204A associated with the first user device 204 and the second environment data 206A associated with the second user device 206. Further, the system 202 is configured to analyze the first environment data and the second environment data. The system 202 is further configured to determine that the first environment data 204A is different from the second environment data 206A based on the analysis of the first environment data 204A and the second environment data 206A. The system 202 is further configured to detect a first set of instructional interactions associated with at least one of the first user device 204 or the first entity 208A based on the determination of the first environment data 204A being different from the second environment data 206A. The first entity 208A is associated with the first user device 204. The system 202 is further configured to apply a language model 202A on the first set of instructional interactions, the first environment data 204A, and the second environment data 206A based on the detection of the first set of instructional interactions. Further, the system 202 is configured to generate a second set of instructional interactions associated with at least one of the second user device 206 or the second entity 208B based on the application of the language model 202A on the first set of instructional interactions, the first environment data 204A, and the second environment data 206A. The second entity 208B is associated with the second user device 206. The system 202 is further configured to output the generated second set of instructional interactions.

In an embodiment, the examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The first user device 204 and the second user device 206 may include suitable logic, circuitry, interfaces, and/or code that may enable users to interact with the system 202. Examples of the first user device 204 and the second user device 206 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that may be configured to render an output generated by the system 202. In some embodiments of the disclosure, the display screen may be an external display device associated with the first user device 204 and the second user device 206. The display screen may be a touch screen which may enable the first entity 208A or the second entity 208B to interact via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electrochromic display, or a transparent display. In some embodiments of the disclosure, the display screen may be realized through several known technologies such as, but are not limited to, at least one of a liquid Crystal Display (LCD) display, a Light Emitting Diode (LED) display, a plasma display, or an Organic LED (OLED) display technology.

In an embodiment, the language model 202A may correspond to a computer-based system or software that exhibits characteristics commonly associated with human intelligence. The language model 202A may be designed to perform tasks that typically require human intelligence, such as problem-solving, learning, reasoning, perception, understanding natural language, and decision-making. AI systems can range from simple rule-based programs to sophisticated, self-learning systems.

The language model 202A may be a sophisticated piece of software that leverages natural language processing (NLP) and machine learning processes to understand, generate, and manipulate human language. For example, the language model 202A may correspond to a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. For example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning processes, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

In an example, the LLMs may be considered to be built on transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. In an example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to the large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted, that a base model in an LLM refers to a pre-trained model that has been trained on a large corpus of data for a general natural language understanding and generation task. The pre-trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

In an example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or majority of the base model's parameters frozen. In particular, the adapter is used to fine-tune the base model for a specific downstream task without extensively modifying its pre-trained parameters. This approach is beneficial when computational resources or labeled task-specific data are limited.

In an embodiment, the database 210 corresponds to an organized collection of data that may be stored and accessed electronically from, for example, the system 202. The database 210 is configured to manage, store, retrieve, and update data efficiently. In an exemplary implementation, the structure of the database 210 typically involves tables, records, and fields that can be managed through various database management systems (DBMS). Examples of the database 210 include but are not limited to, a relational database, a Non-Structured Query Language (SQL) database, a hierarchical database, a network database, a transactional database, a data warehouse, and a distributed database. In an embodiment, the database 210 is configured to store the first environment data 204A associated with the first user device 204 which may include the operating system data, software application data, and software application version data. Further, the database 210 stores instructional interactions that may be used to train the language model 202A. The database 210 is configured to store the second environment data 206A associated with the second user device 206.

In operation, the system 202 is configured to receive the first environment data 204A associated with the first user device 204. In an embodiment, the first environment data 204A corresponds to a specific configuration and a state of the first user device 204. The first environment data 204A includes details such as, but not limited to, an operating system associated with the first user device 204, one or more software applications associated with the first user device 204, hardware specifications associated with the first user device 204, and one or more additional settings that influence the functionality of the one or more software applications on the first user device 204. Further, the first user device 204 is associated with a first entity 208A. For instance, the first user device 204 corresponds to a specific hardware or a software platform that the first entity (say a teacher) employs to access virtual classes. The first user device 204 corresponds to a personal computer, tablet, or any device capable of running the applications for a training session in the virtual environment, and the first environment data 204A refers to the specific software or operating system utilized by the first entity 208A to access the virtual environment.

Moreover, the system 202 is configured to receive the second environment data 206A associated with the second user device 206. In an embodiment, the second environment data 206A corresponds to information that characterizes a specific configuration and the state of the second user device 206. The second environment data 206A includes at least one of the identifier data associated with the second user device 206, the operating system data associated with the second user device 206, or the application data associated with the second user device 206. In an embodiment, the second environment data 206A includes details such as, but is not limited to, an operating system associated with the second user device 206, one or more software applications associated with the second user device 206, hardware specifications associated with the second user device 206, and one or more additional settings that influence the functionality of the one or more software applications on the second user device 206. Further, the second user device 206 is associated with a first entity 208A. For instance, the second user device 206 corresponds to a specific hardware or a software platform that the first entity (say a student) employs to access the virtual environment established by the system 202. The second user device 206 corresponds to a personal computer, tablet, or any device capable of running the applications for a training session in the virtual environment, and the second environment data 206A refers to the specific software or operating system utilized by the second entity 208B to access the virtual environment.

Further, the system 202 is configured to analyze the first environment data 204A and the second environment data 206A. In an embodiment, the system 202 is configured to analyze the first environment data 204A and the second environment data 206A. By way of example, and not by limitation, the system 202 is configured to analyze at least one of the identifier data associated with the first user device 204 and the second user device 206, the operating system associated with each of the first user device 204 and the second user device 206, and the application data associated with each of the first user device 204 and the second user device 206. For instance, the analysis of the first environment data 204A and the second environment data 206A is used for identifying differences in the first environment data 204A and the second environment data 206A that may affect the instructional process in the virtual environment.

Further the system 202 is configured to determine the first environment data 204A is different from the second environment data 206A based on the analysis of the first environment data 204A and the second environment data 206A. For example, if the software application on the first user device 204 is running on version “X” while the application on the second user device is running on version “Y”, the system 202 analyzes these differences in application data. The comparative analysis enables the system 202 to determine how variations in the software application versions and configurations may impact a user experience and instructional effectiveness.

Further, the system 202 is configured to detect a first set of instructional interactions associated with at least one of the first user devices 204 or the first entity 208A based on the determination of the first environment data 204A being different from the second environment data 206A. The first entity 208A is associated with the first user device 204. In an embodiment, the system 202 establishes a virtual environment between the first user device 204 (such as the laptop) or the first entity (such as the teacher), and the second user device 206 (such as a laptop) or the second entity 208B (say the student). The system 202 is configured to detect the first set of instructional interactions associated with the first user device 204 or the first entity 208A based on the determination that the first environment data 204A is different from the second environment data 206A. By way of example, and not by limitation, the first set of instructional interactions corresponds to a series of actions performed on a software application associated with the first user device 204 or the verbal instructions provided by the first entity 208A in the virtual environment. In this example, the first entity 208A is tasked with providing training to the second entity 208B on utilizing the software application (say a software application “ABC”), within the virtual environment established by the system 202. The first entity 208A performs the series of actions on the software application associated with the first user device 204 while delivering verbal instructions to the second entity 208B. The second entity 208B is connected to the virtual environment through the second user device 206. The system 202 is configured to detect the series of actions executed by the first entity 208A on the software application associated with the first user device 204, alongside the verbal instructions conveyed by the first entity 208A in the virtual environment. The set of actions associated with the first user device 204 and the verbal instructions associated with the first entity 208A are collectively referred to as the first set of instructional interactions associated with the first user device 204 or the first entity 208A. For instance, if the first entity 208A demonstrates how to create a document in the software application and verbally instructing the second entity 208B on each step, the system 202 detects the set of instructional interactions. The system 202 is configured to detect the series of actions are performed such as, but not limited to, clicking buttons or navigating menus, and also records the accompanying verbal instructions.

Further, the system 202 is configured to apply the language model 202A on the first set of instructional interactions, the first environment data 204A, and the second environment data 206A based on the detection of the first set of instruction interactions. In an embodiment, based on the detection of the first set of instructional interactions associated with the first user device 204 or the first entity 208A, the system 202 is configured to apply the language model 202A on the first set of instructional interactions. By way of example, and not by limitation, the system 202 applies the language model 202A on the first set of instructional interactions, the first environment data 204A, and the second environment data 206A. The language model 202A is designed to translate the series of actions executed on the first user device 204 into the corresponding second set of instructional interactions for the second user device 206

Further, the system 202 is configured to generate a second set of instructional interactions associated with at least one of the second user device 206 or the second entity 208B based on the application of the language model 202A on the first set of instructional interactions, the first environment data 204A, and the second environment data 206A. The second entity 208B is associated with the second user device 206. The language model 202A takes the first textual description of the first set of instructional interactions, the first environment data, and the second environment data as input and generates an output that corresponds to the second set of instructional interactions associated with at least one of the second user device 206 or the second entity 208B.

Further, the system 202 is configured to output the generated second set of instructional interactions. In an embodiment, the system 202 is configured to output the generated second set of instructional interaction to the second user device 206. In an example, the second set of instructional interactions is displayed on the screen of the second user device 206. In an alternate scenario, the second set of instructional interactions is provided as audio instructions to the second user device 206. The second entity 208B then executes the second set of instructional interactions, either by following the instructions displayed on the screen or by responding to the audio instructions provided on the second user device 206 to carry out the operation

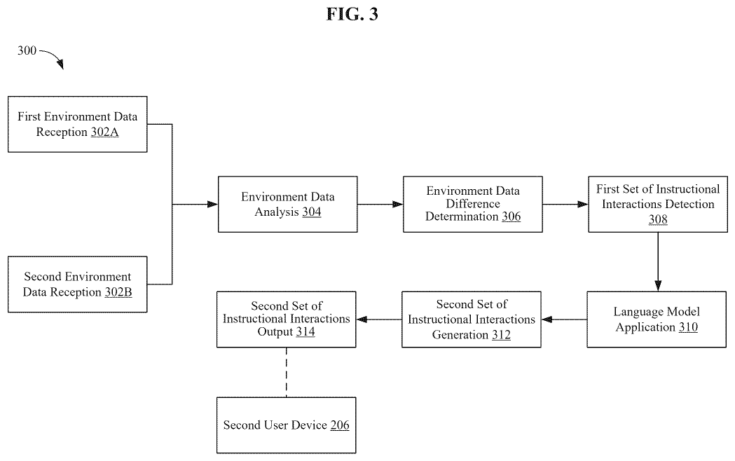

FIG. 3 is a diagram 300 that illustrates one or more operations performed by the system 202 for the generation of instructional interactions in a virtual session, in accordance with an embodiment of the disclosure. FIG. 3 is explained in conjunction with elements from FIG. 1, and FIG. 2. With reference to FIG. 3, the operations may start at 302.

At 302A, a first environment data reception operation is executed. In the first environment data reception operation, the system 202 is configured to receive the first environment data 204A associated with the first user device 204. In an embodiment, the first environment data 204A includes the at least one of the identifier data associated with the first user device 204, the operating system data associated with the first user device 204, or the application data associated with the first user device 204.

By way of example, and not by limitation, the first user device 204 corresponds to at least one of desktop computers, laptops, tablets, smartphones, or a Virtual Reality (VR) device. In some scenarios, the first user device 204 corresponds to a laptop. Further, the first user device 204 (such as the laptop) is associated with the first entity 208A. In this scenario, the first entity 208A corresponds to the teacher. The teacher wants to utilize the first user device 204 to present a presentation to the second entity 208B, where the second entity 208B corresponds to the student. It may be noted that in some exemplary scenarios, the second entity 208B may correspond to more than one student. Further, for presenting the presentation, the system 202 establishes a virtual environment between the first user device 204 associated with the first entity 208A (the teacher) and the second user device 206 associated with the second entity 208B (the student). The virtual environment is, but is not limited to, Collaborative Virtual Environment (CVEs). In some examples, the system 202 establishes the virtual environment between the first user device 204 and the second user device 206 over a server or a cloud-based application.

Further, once the system 202 establishes the virtual environment, and the first entity 208A starts to present the presentation, the system 202 receives the first environment data 204A associated with the first user device 204 (say the laptop) over the WAN 104. As described above, the first environment data 204A includes the at least one of the identifier data associated with the laptop of the teacher, the operating system data associated with the laptop of the teacher, or the application data associated with the laptop of the teacher. In some examples, the system 202 receives the first environment data 204A in the form of an Extensible Markup Language (XML) file. For example, the system 202 receives a first XML file from the first user device 204 that includes the first environment data 204A in a “key”: “value” pair format.

By way of example, and not by limitation, a representation of the first environment data 204A within the first XML file is described below
“UserId”: “Teacher 1”
“platform”: “XYZ”,
“platform version”: “11”.
“app1_name”: “A1”
“app 1_version”: “2311”,
“app1_language”: “English”
“app2_name”. “A2”
“app2_version”: “2022”,
“app2_Ianguage”: “English”.

As described in the example above, the first XML file includes the identifier data associated with the laptop of the teacher. The identifier data is represented in the “key”: “pair” value format as “UserId”: “Teacher 1”, where the “UserId” corresponds to the “key” and “Teacher 1” corresponds to the “value”. Further, the operating system data associated with the laptop of the teacher is represented in the “key”: “pair” value format as “platform”: “XYZ”. In some examples, the “key” associated with the operating system data may be referred to as “platform”. As described in the received first XML file, “teacher 1” has one or more exemplary applications in use (such as A1 and A2). The first XML file includes the application data of at least one of the one or more exemplary applications associated with the laptop of the teacher. In an example, the application data of a first application (“A1”) corresponds to such as, but is not limited to, app1_name, and app1_version app1_language and is represented in the “key”: “pair” value format as app1_name”: “A1”, app 1_version”: “2311”, and app1_language”: “English”, respectively.

Further, upon the reception of the first environment data 204A, the system 202 is configured to receive the second environment data 206A. In an embodiment to receive the second environment data 206A, the control may pass to 302B.

At 302B, a second environment data reception operation is executed. In the second environment data reception operation, the system 202 is configured to receive the second environment data 206A associated with the second user device 206. In an embodiment, the second environment data 206A includes the at least one of the identifier data associated with the second user device 206, the operating system data associated with the second user device 206, or the application data associated with the second user device 206.

In an embodiment, the system 202 is configured to perform the second environment data reception operation similar to the process of the first environment data reception operation described at 302A. Further, the system 202 performs the first environment data reception operation and the second environment data reception operation simultaneously.

By way of example, and not by limitation, the second entity 208B corresponds to the first student (such as “student A”). The student is utilizing the second user device 206 to view the presentation that is being presented by the first entity 208A (the teacher) within the virtual environment. In an example, the system 202 receives the second environment data 206A from the second user device 206 via the WAN 104, where the second environment data 206A is stored in “key”: “value” pair format within a second XML file. A representation of the second environment data 206A within the second XML file is described below
“UserId”: “Student A”
“platform”: “ABC”,
“platform version”: “14”.
“app1_name”: “A1”
“app 1_version”: “2312”,
“app1_language”: “English”
“app2_name”. “B1”
“app2_version”: “10.5”,
“app2_Ianguage”: “English”.

As described in the example above, the second XML file includes the identifier data associated with the laptop of the student (student A). The identifier data is represented in the “key”: “pair” value format as “UserId”: “Student A”, where the “UserId” corresponds to the “key” and “Student A” corresponds to the “value”. Further, the operating system data associated with the laptop of the student is represented in the “key”: “pair” value format as “platform”: “ABC”. In some examples, the “key” associated with the operating system data may be referred to as “platform”. As described in the received second XML file, “Student A” has one or more exemplary applications in use (such as A1 and B1). The second XML file includes the application data of at least one of the one or more exemplary applications associated with the laptop of the student. In an example, the application data of a first application (app1) associated with the second user device 206 corresponds to such as, but is not limited to, app1_name, and app1_version app1_language and is represented in the “key”: “pair” value format as “app1_name”: “A1”, “app 1_version”: “2312”, and “app1_language”: “English”, respectively.

Further, upon the reception of the first environment data 204A and the second environment data 206A, the system 202 is configured to analyze the received first environment data 204A and the second environment data 206A. To analyze the first environment data 204A and the second environment data 206A, the control may pass to 304.

At 304, an environment data analysis operation is executed. In the environment data analysis operation, the system 202 is configured to analyze the first environment data 204A and the second environment data 206A. In an example, the system 202 analyses the first environment data 204A stored within the first XML file and the second environment data 206A stored within the second XML file.

In some examples, the system 202 analyses the first environment data 204A at a first timestamp. Upon the analysis of the first environment data 204A, the system 202 determines that the first user device 204 (the laptop) associated with the first entity 208A (the teacher) is running on the operating system that corresponds to “XYZ”. Further, the system 202 determines that the first application being utilized by the first entity 208A corresponds to “A1”. Further, the system 202 determines that the version of the first application running on the first user device 204 corresponds to app 1_version”: “2311”. The system 202 further determines that the language of the first application running on the first user device 204 corresponds to “app1_language”: “English”.

Similarly, the system 202 analyses the second environment data 206A at a second timestamp. Upon the analysis of the second environment data 206A, the system 202 determines that the second user device 206 (the laptop) associated with the second entity 208B (the student) is running on the operating system that corresponds to “ABC”. Further, the system 202 determines that the first application being utilized by the second entity 208B corresponds to app1_name”: “A1”. Further, the system 202 determines that the version of the first application running on the second user device 206 corresponds to app 1_version”: “2312”. The system 202 further determines that the language of the first application running on the second user device 206 corresponds to “app1_language”: “English”. In an embodiment, the system 202 is configured to analyze the first environment data 204A and the second environment data 206A simultaneously at the first timestamp.

Further, upon the analysis of the first environment data 204A and the second environment data 206A, the system 202 is configured to determine a difference between the first environment data 204A and the second environment data 206A. To determine the difference between the first environment data 204A and the second environment data 206A, the control may pass to 306.

At 306, an environment data difference determination operation is executed. In the environment data difference determination operation, the system, 202 determines that the first environment data 204A associated with the first user device 204 is different from the second environment data 206A associated with the second user device 206 based on the analysis of the first environment data 204A and the second environment data 206A.

In an exemplary scenario, the teacher and the student are in the virtual session within the virtual environment. The system 202 is configured to determine if the first environment data 204A differs from the second environment data 206A based on the analysis of the first environment data 204A and the second environment data 206A. Upon analysis at 304, the system 202 determines that the operating system data associated with the first user device 204 of the first entity 208A corresponds to “XYZ”, and the operating system data associated with the second user device 206 of the second entity 208B corresponds to “ABC”. This determination indicates that the first environment data 204A is different from the second environment data 206A. In an embodiment, the difference between the operating system data of the first user device and the operating system data of the second user device is exemplary and the system 202 is configured to determine the difference between any of the “key”: “value” pair within the first XML file associated with the first user device 204 and the “key”: “value” pair within second XML file associated with the second user device 206.

Further, upon the determination of the difference between the first environment data and the second environment data, the system 202 detects the first set of instructional interactions. For the detection of the first set of instructional interactions, the control may pass to 308.

At 308, a first set of instructional interactions detection operation is executed. In the first set of instructional interactions detection operation, the system 202 is configured to detect the first set of instructional interactions associated with at least one of the first user device 204 or the first entity 208A based on the determination of the first environment data 204A being different from the second environment data 206A. In an embodiment, the first entity 208A is associated with the first user device 204.

By way of example, and not by limitation, the first entity 208A (the teacher) is performing an operation (say opening and accessing a camera of a video conferencing application (“A1”), version “2311”) on the first user device 204. Further, the first entity 208A requires the second entity 208B to replicate the operation on the second user device 206. Once the system 202 receives the first environment data 204A, the system 202 determines from the operating system data associated with the first environment data 204A, that the first user device 204 is operating on an operating system “XYZ” and the video conferencing application that the first entity 208A is using corresponds to say “A1”, version “2311”. Further, upon the reception of the second environment data 206A, the system 202 determines from the operating system data associated with the second environment data 206A, that the second user device 206 is operating on an operating system “ABC” and the video conferencing application that the second entity is using corresponds to say “A1” version “2312”. Based on the determination, the system 202 determines that the operating system on the first user device 204 and the version of the video conferencing application on the first user device 204 is different from the operating system on the second user device 206 and the version of the video conferencing application on the second user device 206.

In an exemplary scenario, as the operating system (“XYZ”) on the first user device 204 and the version of the video conferencing application (“A1”) on the first user device 204 is different from the operating system (“ABC”) on the second user device 206 and the version of the video conferencing application (“A1”) on the second user device 206, the series of actions taken by the first entity 208A to perform the operation (open and access the camera using the video conferencing application) successfully on the first user device 204 may be different to performing the operation (open and access the camera using the video conferencing application) successfully on the second user device 206. For example, for opening and accessing the camera in the video conferencing application (“A1”, version “2311”) on the first user device 204, the first entity 208A performs one step (say step A). Further, opening and accessing the camera in the video conferencing application (“A1”, version “2312”) on the second user device 206 requires two steps (say step B and a step C).

In an embodiment, the system 202 detects the first set of instructional interactions performed by the first entity 208A. In this scenario, the first set of instructional interactions corresponds to the step A. In an example, on the first user device 204, the first entity 208A is displayed with a camera icon within the video conferencing application (“A1”, version “2311”). Once the first entity 208A clicks on the camera icon displayed within the video conferencing application (“A1”, version “2311”), the first entity 208A can open and access the camera. The system 202 detects the step A and is further configured to convert the first set of instructional interactions into a first textual description and apply the language model 202A on the first textual description of the first set of instructional interactions, the first environment data 204A, and the second environment data 206A. In an example, the first textual description of the step A corresponds to “click on camera icon present on top-right corner of display of the A1 application”. To apply the language model 202A on the first textual description of the step A, the first environment data 204A, and the second environment data 206A, the control may pass to 310.

At 310, a language model application operation is executed. In the language model application operation, the system 202 is configured to apply the language model 202A on the first set of instructional interactions, the first environment data 204A, and the second environment data 206A based on the detection of the first set of instructional interactions.

By way of example, and not by limitation, the first set of instructional interactions corresponds to at least the series of actions performed by the first entity 208A to perform the operation on the first user device 204. Further, once the system 202 detects the first set of instructional interactions (say the step A), the system 202 applies the language model 202A on the first textual description of the first set of instructional interactions, the first environment data 204A, and the second environment data 206A. In an exemplary scenario, from the first environment data 204A stored within the first XML file, the system 202 determines that the operating system, the video conferencing application, and the version of the video conferencing application associated with the first user device 204 corresponds to “platform”: “XYZ”, “app1_name”: “A1”, and “app 1_version”: “2311”, respectively. Further, from the second environment data 206A stored within the second XML file, the system 202 determines that the operating system, the video conferencing application, and the version of the video conferencing application associated with the second user device 206 corresponds to “platform”: “ABC”, “app1_name”: “A1”, and “app 1_version”: “2312”, respectively. The system 202 applies the language model 202A on the first textual description of the first set of instructional interactions (step A), the first environment data 204A, and the second environment data 206A. The language model 202A takes the first textual description of the first set of instructional interactions, the first environment data, and the second environment data as input, determines similar steps that can be executed to perform the operation on the second user device 206, and generates an output that corresponds to the second set of instructional interactions associated with at least one of the second user device 206 or the second entity 208B. To generate an output that corresponds to the second set of instructional interactions, the control may pass to 312.

At 312, a second set of instructional interactions generation operations is executed. In the second set of instructional interactions generation operation, the system 202 is configured to generate the second set of instructional interactions associated with at least one of the second user device 206 or the second entity 208B based on the application of the language model 202A on the first set of instructional interactions, the first environment data 204A, and the second environment data 206A. The second entity is associated with the second user device 206.

By way of example, and not by limitation, the application of the language model 202A on the first set of instructional interactions, the first environment data 204A, and the second environment data 206A causes the system 202 to generate the second set of instructional interactions. In an exemplary scenario, the first entity 208A executes the step A to perform the operation associated with opening and accessing the camera using the video conferencing application on the first user device 204. The operating system, the video conferencing application, and the version of the video conferencing application associated with the first user device 204 correspond to “platform”: “XYZ”, “app1_name”: “A1”, and “app 1_version”: “2311”, respectively. The system 202 analyzes the first textual description of the first set of instructional interactions (the step A), the first environment data 204A, and the second environment data 206A using the language model 202A. In an embodiment, the language model 202A is designed to translate the series of actions executed on the first user device 204 into the corresponding second set of instructional interactions for the second user device 206. In an embodiment, the language model 202A may operate through a training process grounded in natural language processing (NLP). Initially, the language model 202A ingests the first textual description of the first set of instructional interactions that are performed on the first user device 204, employing methods such as, but not limited to, tokenization and part-of-speech tagging to parse the input (the first textual description) and understand the context and semantics of the first textual description). The core functionality lies in its ability to analyze these steps and map them to the equivalent second set of instructional interactions for the second user device 206. This capability of the language model 202A can be developed through extensive training on diverse datasets that include examples of operations across various platforms. This training enables the language model 202A to learn how different systems interact with similar commands, enhancing its understanding of operational distinctions.

In an example, based on the application of the language model 202A on the first set of instructional interactions, the first environment data 204A, and the second environment data 206A, the system 202 generates the second set of instructional interactions. The second set of instructional interactions corresponds to the step B and the step C. The second entity 208B needs to perform the generated second set of instructional interactions on the second user device 206 to successfully perform the operation (opening and accessing the camera using the video conferencing application “A1”, version “2312”). The step B corresponds to clicking on the settings icon present in the left-down corner of the display within the video conferencing application. The step C corresponds to clicking on “open camera” icon within the settings of the video conferencing application on the second user device 206.

Further, upon the generation of the second set of instructional interactions, the system is configured to output the generated second set of instructional interactions. To output the second set of instructional interactions, the control may pass to 314.

At 314, a second set of instructional interactions output operation is executed. In the second set of instructional interactions output operation, the system 202 is configured to output the generated second set of instructional interactions. In an example, the second set of instructional interactions is outputted on the second user device 206 associated with the second entity 208B. In a scenario, the second set of instructional interactions is outputted on the display screen of the second user device 206. In an alternate scenario, the second set of instructional interactions is outputted as audio instructions on the second user device 206. The second entity 208B may perform the second set of instructional interactions that may be displayed on the display screen of the second user device 206 or the second set of instructional interactions that may be outputted as audio instructions on the second user device 206 to perform the operation (opening and accessing the camera using the video conferencing application “A1”, version “2312”) on the second user device 206.

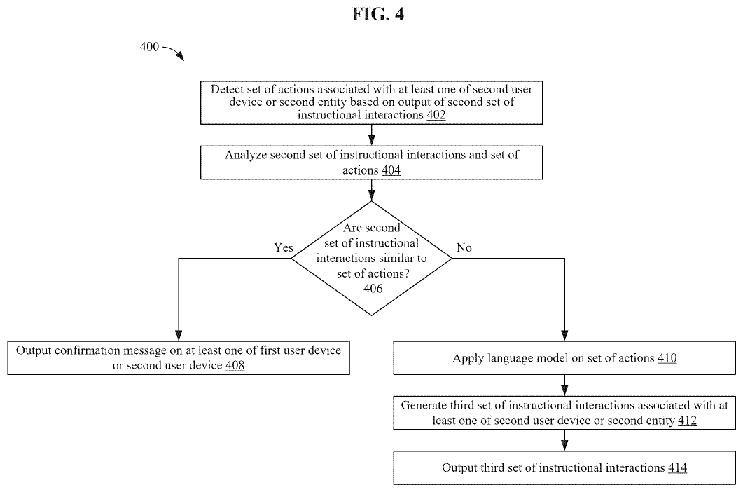

FIG. 4 is a diagram 400 that illustrates a flowchart that depicts a generation of a third set of instructional interactions based on the analysis of the second set of instructional interactions and the set of actions, in accordance with an embodiment of the disclosure. FIG. 4 is explained in conjunction with elements from FIG. 1, FIG. 2, and FIG. 3. With reference to FIG. 4, the method may start at 402.

At 402, the system 202 is configured to detect the set of actions associated with at least one of the second user device 206, or the second entity 208B based on the output of the second set of instructional interactions. In an example, the system 202 outputs the second set of instructional interactions on the second user device 206. The second set of instructional interactions corresponds to at least one of one or more textual descriptions, one or more audio instructions, and one or more visual cues. In an example, the second set of instructional interactions corresponds to for example, the step B (clicking on the settings icon present in the left-down corner of the display within the video conferencing application) and the step C (clicking on “open camera” icon within the settings of the video conferencing application on the second user device 206). In an embodiment, the second set of instructional interactions may be outputted on the display screen of the second user device 206. In an additional embodiment, the second set of instructional interactions may be outputted as the audio instructions via one or more speakers associated with the second user device 206. In an embodiment, the second set of instructional interactions may be generated and outputted in a preferred language (such as but not limited to, English language, Chinese language, Japanese language) of the second entity 208B.

Further, once the second set of instructional interactions is outputted, the second entity 208B performs the set of actions corresponding to each instructional interaction of the second set of instructional interactions. For example, the second entity 208B performs a first action of the set of actions, where the first action corresponds to the execution of a first instructional interaction of the second set of instructional interactions. The first instructional interaction may be the step B. The second entity 208B clicks on the settings icon present in the left-down corner of the display within the video conferencing application “A1”, version “2312”. Further, upon the execution of the first instructional interaction, the second entity 208B performs a second action of the set of actions, where the second action corresponds to the execution of a second instructional interaction of the second set of instructional interactions. The second instructional interaction of the second set of instructional interactions corresponds to step C. The second entity 208B executes the second action of the set of actions. The second entity 208B clicks on “open camera” icon within the settings of the video conferencing application on the second user device 206. The system 202 is configured to detect the first action and the second action and analyze the first instructional interaction, the second instructional interaction, the first action, and the second action.

At 404, the system 202 analyzes the second set of instructional interactions (such as the first instructional interaction and the second instructional interaction) and the set of actions (such as the first action and the second action). In an example, the system 202 is configured to convert the first instructional interaction and the second instructional interaction associated with the second set of instructional interactions into a second textual description. The second textual description may be in a text format. In an embodiment, the second textual description may be, for example, “click on the settings icon present in the left-down corner of the display within the video conferencing application then click on “open camera” icon within the settings of the video conferencing application”. Further, the system 202 analyzes the second textual description associated with the second set of instructional interactions, the first action, and the second action.

At 406, the system 202 is configured to determine if the second set of instructional interactions is similar to the set of actions based on the analysis of the second set of instructional interactions and the set of actions. In an example, the system 202 determines if the second entity 208B performed the first action corresponding to the first instructional interaction associated with the second set of instructional interactions correctly. Further, the system 202 determines if the second entity 208B performed the second action corresponding to the second instructional interaction associated with the second set of instructional interactions correctly.

Further, based on the determination that the second entity 208B performed the first action and the second action correctly, the system 202 is configured to output a confirmation message on at least one of the first user device 204 or the second user device 206 at 408. The confirmation message is indicative of an execution of the second set of instructional interactions on the second user device 206. In an example, the first user device 204 is associated with the first entity 208A (the teacher), and the second user device 206 is associated with the second entity 208B (the student). The system 202 notifies the teacher of the successful execution of the second set of instructional interactions on the second user device 206 associated with the student by outputting the confirmation message on the display screen associated with the first user device 204. Similarly, the system 202 notifies the student of the successful execution of the second set of instructional interactions on the second user device 206 by outputting the confirmation message on the display screen associated with the second user device 206.

Referring back to 406, if the system 202 determines at 406 that the second set of instructional interactions is different from the set of actions, the control may pass to 410.

At 410, the system 202 is configured to apply the language model 202A on the set of actions. In an example, the second entity 208B performs the first action correctly but performs the second action incorrectly, where instead of clicking on “open camera” icon within the settings of the video conferencing application, the second entity 208B clicks on “open audio” icon within the settings of the video conferencing application. Due to this, the second entity 208B is unable to open the camera using the video conferencing application “A1”, version “2312”.

Further, upon the determination that the second entity 208B has performed the second action incorrectly, the system 202 applies the language model 202A on the first action and the second action of the set of actions.

At 412, the system 202 is configured to generate a third set of instructional interactions associated with the at least one of the second user device 206 or the second entity based on the application of the language model 202A on the set of actions. In an embodiment, the third set of instructional interactions is customized for the at least one of the second user device 206 or the second entity 208B based on the determination that the second set of instructional interactions is different from the set of actions.

In an example, based on the application of the language model 202A on the first action and the second action of the set of actions, the system 202 generates the third set of instructional interactions that need to be performed for successful execution of the operation (opening and accessing the camera using the video conferencing application). The third set of instructional interactions includes for example, a first instructional interaction associated with the third set of instructional interactions, a second instructional interaction associated with the third set of instructional interactions, and a third instructional interaction associated with the third set of instructional interactions.

Further, the first instructional interaction associated with the third set of instructional interactions corresponds to performing a step D, the second instructional interaction associated with the third set of instructional interactions corresponds to the first instructional interaction (performing the step B) associated with the second set of instructional interactions. The third instructional interaction associated with the third set of instructional interactions corresponds to the second instructional interaction (performing the step C) associated with the second set of instructional interactions. In simple terms, an updated sequence for execution of the operation on the second user device 206 corresponds to performing the step D, performing the step B, and performing the step C sequentially. The step D corresponds to clicking on a User Interface (UI) element corresponding to a button labeled as “back”.

Further, to execute the third set of instructional interactions, the second entity 208B is required to execute the set of actions that may be updated according to the third set of instructional interactions. In an example, an updated set of actions corresponds to an updated first action, an updated second action, and a third action. The updated first action corresponds to performing the step D, the updated second action corresponds to performing the step B, and the third action corresponds to performing the step C.

At 414, the system 202 is configured to output the generated third set of instructional interactions on the second user device 206. In an embodiment, the third set of instructional interactions may be outputted on the display screen of the second user device 206. In an additional embodiment, the third set of instructional interactions may be outputted as the audio instructions via the one or more speakers associated with the second user device 206. In an embodiment, the third set of instructional interactions may be generated and outputted in a preferred language (such as but not limited to, the English language, the Chinese language, and the Japanese language) of the second entity 208B.

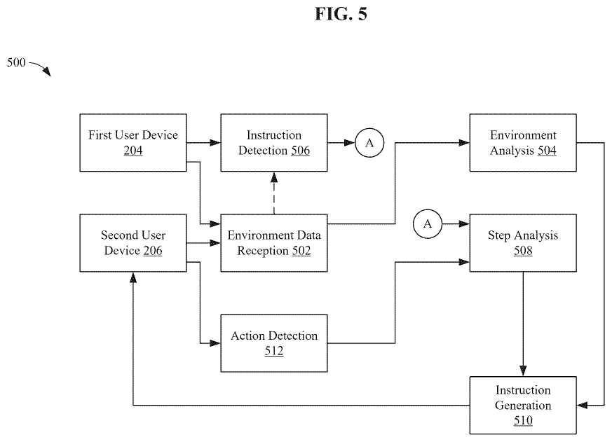

FIG. 5 is a diagram 500 that illustrates exemplary operations for the generation of instructional interactions in a virtual session, in accordance with an embodiment of the disclosure. FIG. 5 is explained in conjunction with elements from FIG. 1, FIG. 2, FIG. 3, and FIG. 4. With reference to FIG. 4, the operations may start at 502.

At 502, an environment data reception operation is executed. In an embodiment, the system 202 is configured to receive the first environment data 204A associated with the first user device 204. Further, the system 202 is configured to receive the second environment data 206A associated with the second user device 206. By way of example, and not by limitation, the first user device 204 (such as a first laptop) is associated with the first entity 208A (such as the teacher) utilizing the operating system (such as “XYZ” version “P”) and the software application (such as the video conferencing software application “A1” version “S”). Similarly, the second user device 206 (such as a second laptop) is associated with the second entity 208B (such as the student A) utilizing the operating system (such as “ABC” version “Q”) and the software application (such as the video conferencing software application “A1” version “T”). In an embodiment, the system 202 receives the first XML file from the first user device 204 that includes the first environment data 204A in a “key”: “value” pair format. Similarly, the system 202 receives the second XML file from the second user device 206 that includes the second environment data 206A in a “key”: “value” pair format. In an example, the first XML file includes the identifier data associated with the laptop of the teacher. The identifier data is represented in the “key”: “pair” value format as “UserId”: “Teacher”, where the “UserId” corresponds to the “key” and “Teacher” corresponds to the “value”. Similarly, the second XML file includes the identifier data associated with the laptop of the student (student A). The identifier data is represented in the “key”: “pair” value format as “UserId”: “Student A”, where the “UserId” corresponds to the “key” and “Student A” corresponds to the “value”. The detail of the environment reception operation is described in FIG. 3.

At 504, an environment analysis operation is executed. In an embodiment, the system 202 is configured to analyze the first environment data 204A and the second environment data 206A to determine that the first environment data 204A associated with the first user device 204 is different from the second environment data 206A associated with the second user device 206. In an example, the system 202 analyses the first environment data 204A stored within the first XML file and the second environment data 206A stored within the second XML file. Further, detail about the environment analysis operation is provided in FIG. 3.

At 506, an instruction detection operation is executed. In an embodiment, the system 202 is configured to detect the first set of instructional interactions associated with at least one of the first user device 204 or the first entity 208A based on the determination of the first environment data 204A being different from the second environment data 206A. In an example, if the teacher performs the series of actions on the first laptop, and simultaneously provides the verbal instruction, the system detects the series of actions and the verbal instruction as the first set of instructional interactions. Further, the system 202 is configured to generate the first textual description associated with each of action associated with the series of actions and the verbal instructions.

In a scenario, the first entity 208A, such as the teacher, is conducting training for the second entity 208B, referred to as student A1. The training involves operations like opening and accessing the camera using the video conferencing application. During this process, the first entity 208A executes the series of actions on the first user device 204 while simultaneously providing verbal instructions to the second entity 208B through the established virtual environment. The system 202 is configured to detect the series of actions performed on the first user device 204 and the verbal instructions associated with the first entity 208A. Further, the system 202 is configured to generate the first textual description that encapsulates the first set of instructional interactions. For example, the first textual description takes the form of a text document outlining one or more steps used for completing the task. In some embodiments, the system 202 generates supplementary materials such as screenshots associated with the first user device 204 or one or more gif files to corresponding to each instructional interaction of the first set of instructional interactions. The detail of the instruction detection operation is described in FIG. 3.

At 508, a step analysis operation is executed. In an embodiment, the system 202 is configured to determine each instructional interaction of the first set of instructional interactions. In an embodiment, the system 202 is configured to modify the first set of instructional interactions associated with at least one of the first user device 204, or the first entity 208A to remove one or redundant instructional interactions in the first set of instructional interactions. By way of example, and not by limitation, the system 202 modifies the first set of instructional interactions associated with either the first user device 204 or the first entity 208A by removing one or more redundant instructional interactions. This modification process is used for streamlining the first set of instructional interactions, ensuring that the second entity 208B is presented with clear and concise guidance without redundant instructional interactions. By identifying and eliminating duplicate or overlapping instructions, the system 202 enhances the overall effectiveness of the training material provided in the virtual session.

The system 202 is configured to generate the second set of instructional interactions associated with the at least one of the second user device or the second entity based on the modification of the first set of instructional interactions. By way of example, and not by limitation, the system 202 generates a second set of instructional interactions tailored specifically for either the second user device 206 or the second entity 208B. This generation is based on the modified first set, ensuring that the second set reflects only the most relevant steps for successful task completion. For example, if the first entity 208A provides instructions that include multiple steps for accessing a feature in the software application, some of which may be repetitive, the system 202 analyzes each instructional interaction of the first set of instructional interactions. Further, the system 202 removes any redundant instructional interaction, resulting in a more streamlined first set of instructional interactions.

In one embodiment, the system 202 effectively removes one or redundant instructional interactions from the first set of instructional interactions. For instance, if the first entity 208A performs an action while simultaneously providing verbal instructions, the system 202 detects both as separate instructional interactions. However, since these two instructional interactions are redundant representing the same instructional content, the system 202 recognizes this overlap. Further, the system 202 analyzes the entire set of the first set of instructional interactions and removes one or redundant instructional interactions. This process ensures that unique and meaningful interactions from the first set of instructional interactions are retained, creating a streamlined and concise the first textual description that accurately reflects the first set of instructional interactions provided by the first entity 208A.

At 510, an instruction generation operation is executed. In an embodiment, the system 202 is configured to determine differences in the first environment data 204A, and the second environment data 206A. In an embodiment, the difference in the first environment data 204A, and the second environment data 206A is determined upon the execution of the environment analysis operation at 504. Further, upon the determination that the first environment data 204A is different from the second environment data 206A, the system 202 is configured to execute the instruction generation operation. Details about determining the difference between the first environment data 204A and the second environment data 206A are provided in FIG. 3.

The system 202 is further configured to detect the first set of instructional interactions associated with at least one of the first user device 204, or the first entity 208A based on the determination of the first environment data 204A being different from the second environment data 206A. In an embodiment, the system 202 generates the first textual description that encapsulates the first set of instructional interactions based on the detected first set of instructional interactions. Further, the system 202 is configured to generate a second set of instructional interactions associated with at least one of the second user device 206, or the second entity 208B. In an embodiment, the system 202 generates the second set of instructional interactions based on the differences in the first environment data 204A, the second environment data 206A, and the first textual description associated with the first set of instructional interactions. In an example, the system 202 determines the difference between the first environment data 204A associated with the teacher and the second environment data 206A associated with the student. Further, the system 202 determines the first set of instructional interactions associated with the first environment data 204A. Further, the system 202 utilizes the language model 202A to generate the second set of instructional interactions based on the determined difference, and the first set of instructional interactions. In an embodiment, the system 202 utilizes the language model 202A to generate the second set of instructional interactions. The language model 202A assesses whether the first set of instructional interactions associated with the first user device 204 or the first entity 208A differs from the required steps for the second user device 206. Based on this analysis, the language model 202A generates a second set of instructional interactions to achieve the outcomes initially produced on the first user device 204. In various embodiments, the second set may instructional interactions include various formats such as one or more textual descriptions one or more audio instructions, and one or more visual cues delivered on the second user device 206. Additionally, the second set of instructional interactions functions as an interactive wizard that guides the second entity 208B through the required process step-by-step.

In an embodiment, the system 202 is configured to retrieve a set of applications based on the analysis of the first environment data 204A and the second environment data 206A. The set of applications is associated with a first application installed on the first user device 204. Further, the system 202 is configured to generate a set of instructions associated with a usage of at least one application of the set of applications. The system 202 is configured to output the generated set of instructions. In an embodiment, the system 202 retrieves a set of applications based on the analysis of the first environment data 204A and the second environment data 206A. This set of applications is linked to a primary application installed on the first user device 204. By evaluating the first environment data 204A and the second environment data 206A, the system 202 identifies compatible applications that may be utilized in the training process. Once the compatible applications are identified, the system 202 generates a set of instructions pertaining to the usage of at least one application from the analyses compatible applications. The set of instructions is used for guiding the second entity 208B, particularly when there are differences in software versions or functionalities between the first user device 204 and the second user device 206. The system 202 outputs the generated set of instructions, ensuring that the second entity 208B have clear guidance on how to proceed with the step associated with the first set of instructional interactions. For example, if the second entity 208B does not have the software application installed on their second user device 206 as that used by the first entity 208A on the first user device 204. Further, the system 202 recommends the compatible software applications available on the second user device. This recommendation is used for maintaining continuity in training and ensuring that all participants can engage with similar functionalities. Correspondingly, a tailored second set of instructional interactions will be generated to ensure that equivalent results can be achieved using the compatible software application.

At 512, an action detection operation is executed. In an embodiment, the system is configured to detect a set of actions associated with at least one of the second user device 206, or the second entity based on the output of the second set of instructional interactions. In an embodiment, the system 202 is configured to generate a text document associated with each of the actions of the set of actions associated with the second user device 206. In this embodiment, the system 202 is configured to detect the set of actions associated with either the second user device 206 or the second entity 208B, based on the output generated from the second set of instructional interactions. This detection process is crucial for monitoring how effectively the second entity 208B is able to follow the second set of instructional interactions. As the second entity 208B engages with the second set of instructional interactions, the system 202 captures the set of actions performed on the second user device 206 by the second entity 208B. This includes interactions such as clicks, navigations, or any relevant operations that demonstrate the student's engagement with the training material. Furthermore, the system 202 is configured to generate a text document associated with each action within this detected set of actions. This provides a record of the actions taken by the second entity 208B, facilitates analysis of their performance, and allows for feedback to be tailored to their specific interactions.

Upon completion of the action detection operation, the system 202 is configured to perform the step analysis operation. In an embodiment, the system 202 is configured to analyze the second set of instructional interactions and the set of actions associated with the second user device 206 or the second entity 208B. The system 202 compares each of the set of actions with the second set of instructional interactions.

Upon completion of the step analysis operation, the system 202 is configured to perform the instruction generation operation. In an embodiment, if the system 202 determines the second set of instructional interactions is different from the set of actions based on the analysis of the second set of instructional interactions and the set of actions then the system 202 is configured to apply the language model 202A on the set of actions based on the determination that the second set of instructional interactions is different from the set of actions. Further, the system 202 is configured to generate a third set of instructional interactions associated with the at least one of the second user device or the second entity based on the application of the language model 202A on the set of actions. Once the language model 202A is applied, the system 202 analyzes the specific actions performed by the second entity 208B in relation to the second set of instructional interactions. This analysis allows the system 202 to identify gaps or errors in execution by the second entity 208B. Based on this evaluation, the system 202 generates a third set of instructional interactions tailored specifically for either the second user device 206 or the second entity 208B. The third set of instructional interactions is used to correct any identified issues and guide the second entity 208B through the steps to achieve the desired outcomes.

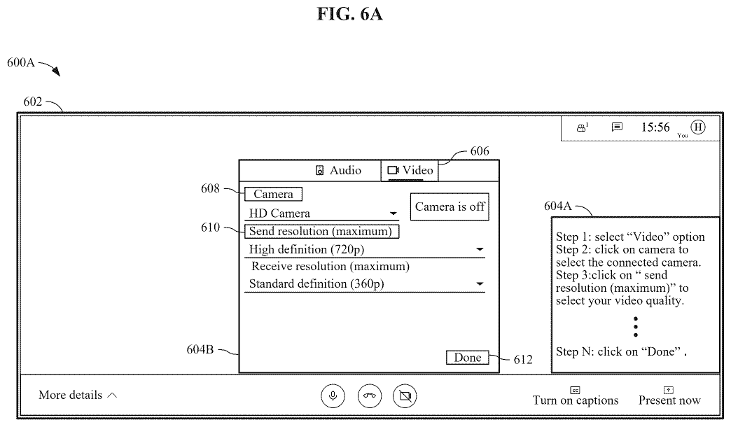

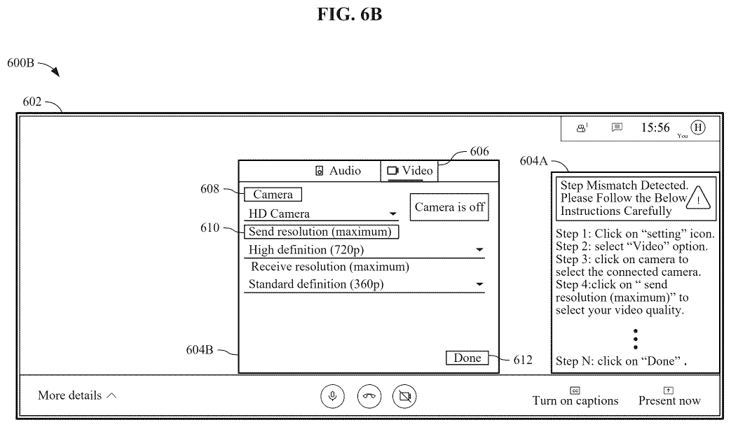

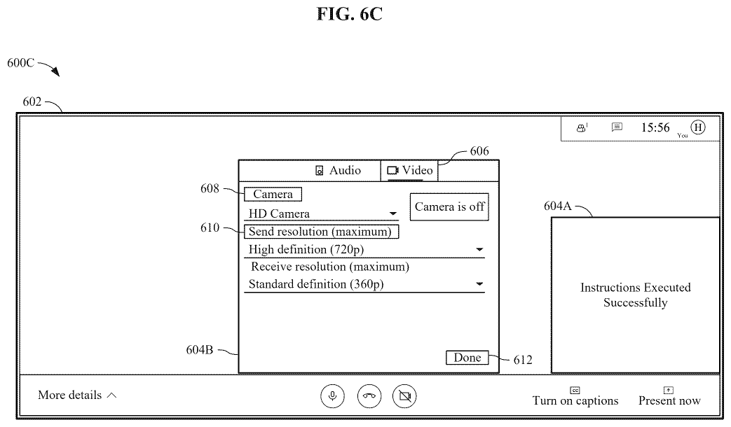

FIG. 6A is a diagram 600A that illustrates a first user interface associated with generation of instructional interactions in a virtual session, in accordance with an embodiment of the disclosure. FIG. 6A is explained in conjunction with elements from FIG. 1, FIG. 2, FIG. 3, FIG. 4, and FIG. 5.

As shown in FIG. 6A, the second entity 208B is displayed with a user interface 602. The user interface 602 may correspond to the user interface of the video conferencing application (“A1”), version “2312” rendered on the second user device 206. Further, the user interface 602 includes a first display box labeled as 604A, and a second display box labeled as 604B. In an example, the first display box 604A includes the second set of instructional interactions generated by the system 202. Further, the second display box 604B includes one or more User Interface (UI) elements (such as a first UI element 606, a second UI element 608, a third UI element 610, and up to an Nth UI element 612).

By way of example, and not by limitation, the system 202 generates and renders the second set of instructional interactions associated with performing an operation (opening and accessing the camera using the video conferencing application (“A1”), version “2312”). The second set of instructional interactions includes one or more steps. A first step of the one or more steps that may be rendered on the first display box 604A is labeled as “Step 1: Select “Video” option, a second step of the one or more steps that may be rendered on the first display box 604A is labeled as “Step 2: Click on the camera to select the connected camera”, a third step of the one or more steps that may be rendered on the first display box 604A is labeled as “Step 3: click on “send resolution (maximum)” to select your video quality”, up to an Nth step of the one or more steps that may be rendered on the first display box 604A is labeled as “Step N: click on “Done”.

Further, the second entity 208B (the student) is required to perform the set of actions corresponding to the respective rendered one or more steps for the successful execution of the operation on the second user device 206. To perform the first action of the set of actions corresponding to the first step, the second entity clicks on the first UI element 606 that is displayed on the second display box 604B. The first UI element 606 may be a button that is labeled as “video”. Further, upon clicking the first UI element 606, the second entity 208B is required to perform the second action of the set of actions corresponding to the second step. The second step may be clicking on the second UI element 608 rendered on the second display box 604B. In an example, the second UI element 608 may be a drop-down menu that is labeled as “camera”. The second entity 208B selects the preferred functional camera (for example, the camera of the second user device 206 or an external webcam). Further, upon clicking the second UI element 608, the second entity 208B is required to perform the third action of the set of actions corresponding to the third step. The third step may be clicking on the third UI element 610 rendered on the second display box 604B. In an example, the third UI element 610 may be a drop-down menu that is labeled as “send resolution (maximum)”. In an embodiment, the second entity 208B selects “high definition (720p)”. Similarly, the second entity 208B is required to perform the Nth action of the set of actions corresponding to the Nth step. The Nth step may be clicking on the Nth UI element 612 rendered on the second display box 604B. The Nth UI element may be a button labeled as “Done”. Upon successful execution of the set of actions, the second entity 208B may open and access the camera using the video conferencing application (“A1”), version “2312”.

FIG. 6B is a diagram 600B that illustrates a second user interface associated with generation of instructional interactions in a virtual session, in accordance with an embodiment of the disclosure. FIG. 6B is explained in conjunction with elements from FIG. 1, FIG. 2, FIG. 3, FIG. 4, FIG. 5, and FIG. 6A.

In an embodiment, the system 202 is configured to detect the set of actions associated with at least one of the second user device 206, or the second entity 208B based on the output of the second set of instructional interactions. Further, the system 202 is configured to determine whether the second set of instructional interactions is different from the set of actions based on the analysis of the second set of instructional interactions and the set of actions. In an example, the system 202 is configured to detect the set of actions associated with the second entity 208B based on the second set of instructional interactions. Further, based on the determination that the second set of instructional interactions is different from the set of actions, the system 202 is configured to apply the language model 202A to the set of actions. In an example, the second set of interactional instructions displayed on the first display box 604A is associated with the second user device 206. The second set of interactional interactions guides the second entity 208B through operations such as opening and accessing the camera using the video conferencing application. The steps rendered in the first display box 604A may include:
“Step 1: Select the “Video” option.”
“Step 2: Click on the camera to select the connected camera.”
“Step 3: Click on “send resolution (maximum)” to choose your video quality.”
“Step N: Click on “Done.””

In an embodiment, the second entity 208B may not be able to follow the steps in the second set of instructional interactions. In an example, the second entity 208B is not able to access the second display box 604B on the second user device 206.

Further, the system 202 is configured to generate the third set of instructional interactions associated with the at least one of the second user device 206, or the second entity 208B based on the application of the language model 202A on the set of actions. In an example, the third set of instructional interactions includes an additional step that provides a way to access the second display box 604B on the second user device.

In an embodiment, the system 202 is configured to output the generated third set of instructional interactions. In an example, the first display box 604A is updated and displays a warning message such as, but not limited to, “Step Mismatch Detected. Please Follow the Below Instructions Carefully”, and displays the step associated with the third set of instructional interaction. For instance, the displayed third set of instructional interactions provides the additional step associated with the display of the second display box 604B and further steps to achieve the results associated with the first set of instructional interactions. The updated steps based on the third set of instructional interactions are rendered in the first display box 604A. The first display box 604A may include:
“Step 1: Click on “setting” icon”
“Step 2: Select the “Video” option.”
“Step 3: Click on the camera to select the connected camera.”
“Step 4: Click on “send resolution (maximum)” to choose your video quality.”
“Step N: Click on “Done.””

FIG. 6C is a diagram 600C that illustrates a second user interface associated with generation of instructional interactions in a virtual session, in accordance with an embodiment of the disclosure. FIG. 6B is explained in conjunction with elements from FIG. 1, FIG. 2, FIG. 3, FIG. 4, FIG. 5, FIG. 6A, and FIG. 6B.

In an embodiment, the system 202 is configured to detect the set of actions associated with at least one of the second user device 206, or the second entity 208B based on the output of the second set of instructional interactions. Further, the system is configured to determine the second set of instructional interactions is similar to the set of actions based on the analysis of the second set of instructional interactions and the set of actions. In an example, the system 202 is configured to detect the set of actions associated with the second user device 206 or the second entity 208B based on the output generated from the second set of instructional interactions. This detection process is used for evaluating how effectively the second entity 208B is executing the provided instructions. As the system 202 analyzes the detected set of actions, further, the system 202 compares the set of actions to the second set of instructional interactions to determine their similarity. For instance, if the second set of instructional interactions includes steps like selecting a video option, clicking on a camera, and adjusting video resolution, the system 202 assesses whether the set of actions taken by the second entity 208B aligns with the second set of instructional interactions.

The system 202 is configured to output the confirmation message on at least one of the first user device or the second user device. The confirmation message is indicative of an execution of the second set of instructional interactions on the second user device. By way of example, and not by limitation, upon successful execution of the set of actions, the system 202 is configured to output a confirmation message on at least one of the first user device 204, and the second user device 206. The confirmation message indicates that the second set of instructional interactions has been successfully executed on the second user device 206. For example, if the second entity 208B completes all required steps to access their camera using the video conferencing application, the confirmation message may appear stating, “Instructions Executed Successfully.”

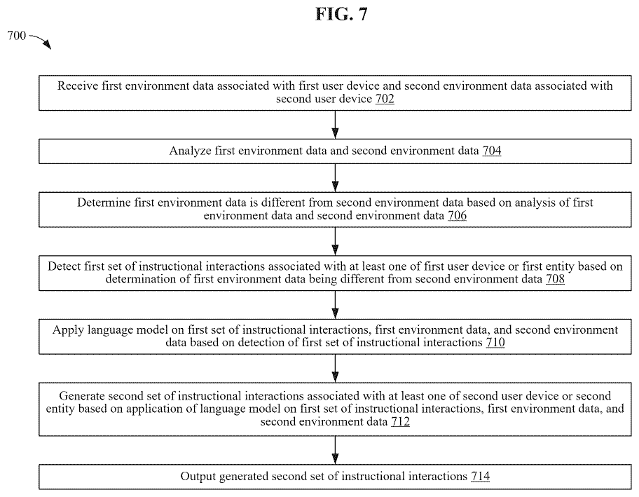

FIG. 7 illustrates a flowchart 700 that illustrates an exemplary method for the generation of instructional interactions in a virtual session, in accordance with an embodiment of the disclosure. FIG. 7 is explained in conjunction with elements of FIG. 1, FIG. 2, FIG. 3, FIG. 4, FIG. 5, FIG. 6A, FIG. 6B, and FIG. 6C. With reference to FIG. 7, there is shown a flowchart 700. The operations of the exemplary method may be executed by any computing system, for example, by the computer 102 of FIG. 1 or the system 202 of FIG. 2. The operations of the flowchart 700 may start at 702.

At 702, the first environment data 204A associated with the first user device 204 and the second environment data 206A associated with the second user device 206 is received. In an embodiment, the system 202 is configured to receive the first environment data 204A associated with the first user device 204 and the second environment data 206A associated with the second user device 206.

At 704, the first environment data 204A and the second environment data 206A are analyzed. In an embodiment, the system 202 is configured to analyze the first environment data 204A and the second environment data 206A.

At 706, the first environment data 204A is different from the second environment data 206A is determined based on the analysis of the first environment data 204A and the second environment data 206A. In an embodiment, the system 202 is configured to determine the first environment data 204A is different from the second environment data 206A based on the analysis of the first environment data 204A and the second environment data 206A.

At 708, the first set of instructional interactions associated with the at least one of the first user device 204 or first entity 208A is detected based on the determination of the first environment data 204A being different from the second environment data 206A. The first entity 208A is associated with the first user device. In an embodiment, the system 202 is configured to detect the first set of instructional interactions associated with the at least one of the first user device 204 or first entity 208A based on the determination of the first environment data 204A being different from the second environment data 206A. The first entity 208A is associated with the first user device.

At 710, the language model 202A is applied on the first set of instructional interactions, the first environment data 204A, and the second environment data 206A based on the detection of the first set of instructional interactions. In an embodiment, the system 202 is configured to apply the language model 202A on the first set of instructional interactions, the first environment data 204A, and the second environment data 206A based on the detection of the first set of instructional interactions.

At 712, the second set of instructional interactions associated with the at least one of the second user device 206 or the second entity 208B is generated based on the application of the language model 202A on the first set of instructional interactions, the first environment data 204A, and the second environment data 206A. The second entity 208B is associated with the second user device 206. In an embodiment, the system 202 is configured to generate, the second set of instructional interactions associated with the at least one of the second user device 206 or the second entity 208B based on the application of the language model 202A on the first set of instructional interactions, the first environment data 204A, and the second environment data 206A. The second entity 208B is associated with the second user device 206.

At 714, the generated second set of instructional interactions is outputted. In an embodiment, the system 202 is configured to output the generated second set of instructional.

In various embodiments of the disclosure, a computer program product for generation of instructional interactions in a virtual session is described. The computer program product includes a computer-readable storage media having program instructions stored on the computer-readable storage media to perform operations. The operations include receiving first environment data associated with a first user device and second environment data associated with a second user device. The operations further include analyzing the first environment data and the second environment data. The operations further include determining whether the first environment data is different from the second environment data based on the analysis of the first environment data and the second environment data. The operations further include detecting a first set of instructional interactions associated with at least one of the first user device or a first entity based on the determination of the first environment data being different from the second environment data. The first entity is associated with the first user device. The operations further include applying a language model on the first set of instructional interactions, the first environment data, and the second environment data based on the detection of the first set of instructional interactions. The operations further include generating a second set of instructional interactions associated with at least one of the second user device or a second entity based on the application of the language model on the first set of instructional interactions, the first environment data, and the second environment data. The second entity is associated with the second user device. The operations include outputting the generated second set of instructional interactions.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, first environment data associated with a first user device and second environment data associated with a second user device;
analyzing, by the computer, the first environment data and the second environment data;
determining, by the computer, the first environment data is different from the second environment data based on the analysis of the first environment data and the second environment data;
detecting, by the computer, a first set of instructional interactions associated with at least one of the first user device or a first entity based on the determination of the first environment data being different from the second environment data, wherein the first entity is associated with the first user device;
applying, by the computer, a language model on the first set of instructional interactions, the first environment data, and the second environment data based on the detection of the first set of instructional interactions;
generating, by the computer, a second set of instructional interactions associated with at least one of the second user device or a second entity based on the application of the language model on the first set of instructional interactions, the first environment data, and the second environment data, wherein the second entity is associated with the second user device; and
outputting, by the computer, the generated second set of instructional interactions.

2. The computer-implemented method of claim 1, wherein the computer-implemented method further comprising:
detecting, by the computer, a set of actions associated with at least one of the second user device or the second entity based on the output of the second set of instructional interactions;
analyzing, by the computer, the second set of instructional interactions and the set of actions;
determining, by the computer, the second set of instructional interactions is different from the set of actions based on the analysis of the second set of instructional interactions and the set of actions;
applying, by the computer, the language model on the set of actions based on the determination that the second set of instructional interactions is different from the set of actions;
generating, by the computer, a third set of instructional interactions associated with the at least one of the second user device or the second entity based on the application of the language model on the set of actions; and
outputting, by the computer, the generated third set of instructional interactions.

3. The computer-implemented method of claim 2, wherein the third set of instructional interactions is customized for the at least one of the second user device or the second entity based on the determination that the second set of instructional interactions is different from the set of actions.

4. The computer-implemented method of claim 1, further comprising:
detecting, by the computer, a set of actions associated with at least one of the second user device or the second entity based on the output of the second set of instructional interactions;
analyzing, by the computer, the second set of instructional interactions and the set of actions;
determining, by the computer, the second set of instructional interactions is similar to the set of actions based on the analysis of the second set of instructional interactions and the set of actions; and
outputting, by the computer, a confirmation message on at least one of the first user device or the second user device, wherein the confirmation message is indicative of an execution of the second set of instructional interactions on the second user device.

5. The computer-implemented method of claim 1, further comprising:
modifying, by the computer, the first set of instructional interactions associated with the at least one of the first user device or the first entity to remove one or more redundant instructional interactions in the first set of instructional interactions; and
generating, by the computer, the second set of instructional interactions associated with the at least one of the second user device or the second entity based on the modification of the first set of instructional interactions.

6. The computer-implemented method of claim 1, further comprising:
retrieving, by the computer, a set of applications based on the analysis of the first environment data and the second environment data, wherein the set of applications is associated with a first application installed on the first user device;
generating, by the computer, a set of instructions associated with a usage of at least one application of the set of applications; and
outputting, by the computer, the generated set of instructions.

7. The computer-implemented method of claim 1, further comprising:
converting, by the computer, the first set of instructional interactions into a first textual description, wherein the first textual description is in a text format; and
applying, by the computer, the language model on the first textual description, the first environment data, and the second environment data.

8. The computer-implemented method of claim 1, wherein the first environment data comprises at least one of identifier data associated with the first user device, operating system data associated with the first user device, or application data associated with the first user device.

9. The computer-implemented method of claim 1, further comprising generating, by the computer, the first set of instructional interactions and the second set of instructional interactions in a multimodal format.

10. The computer-implemented method of claim 1, wherein the first set of instructional interactions and the second set of instructional interactions comprises at least one of one or more textual descriptions, one or more audio instructions, and one or more visual cues.

11. A computer system, comprising:
a processor set;
one or more computer-readable storage media; and
program instructions stored on the one or more computer-readable storage media, the program instructions executable by the processor set to cause the processor set to:
receive first environment data associated with a first user device and second environment data associated with a second user device;
analyze the first environment data and the second environment data;
determine the first environment data is different from the second environment data based on the analysis of the first environment data and the second environment data;
detect a first set of instructional interactions associated with at least one of the first user device or a first entity based on the determination of the first environment data being different from the second environment data, wherein the first entity is associated with the first user device;
apply a language model on the first set of instructional interactions, the first environment data, and the second environment data based on the detection of the first set of instructional interactions;
generate a second set of instructional interactions associated with at least one of the second user device or a second entity based on the application of the language model on the first set of instructional interactions, the first environment data, and the second environment data, wherein the second entity is associated with the second user device; and
output the generated second set of instructional interactions.

12. The computer system of claim 11, wherein the program instructions further cause the processor set to:
detect a set of actions associated with at least one of the second user device or the second entity based on the output of the second set of instructional interactions;
analyze the second set of instructional interactions and the set of actions;
determine the second set of instructional interactions is different from the set of actions based on the analysis of the second set of instructional interactions and the set of actions;
apply the language model on the set of actions based on the determination that the second set of instructional interactions is different from the set of actions;
generate a third set of instructional interactions associated with the at least one of the second user device or the second entity based on the application of the language model on the set of actions; and
output the generated third set of instructional interactions.

13. The computer system of claim 12, wherein the third set of instructional interactions is customized for the at least one of the second user device or the second entity based on the determination that the second set of instructional interactions is different from the set of actions.

14. The computer system of claim 11, wherein the program instructions further cause the processor set to:
detect a set of actions associated with at least one of the second user device or the second entity based on the output of the second set of instructional interactions;
analyze the second set of instructional interactions and the set of actions;
determine the second set of instructional interactions is similar to the set of actions based on the analysis of the second set of instructional interactions and the set of actions; and
output a confirmation message on at least one of the first user device or the second user device, wherein the confirmation message is indicative of an execution of the second set of instructional interactions on the second user device.

15. The computer system of claim 11, wherein the program instructions further cause the processor set to:
modify the first set of instructional interactions associated with the at least one of the first user device or the first entity to remove one or more redundant instructional interactions in the first set of instructional interactions; and
generate the second set of instructional interactions associated with the at least one of the second user device or the second entity based on the modification of the first set of instructional interactions.

16. The computer system of claim 11, wherein the program instructions further cause the processor set to:
retrieve a set of applications based on the analysis of the first environment data and the second environment data, wherein the set of applications is associated with a first application installed on the first user device;
generate a set of instructions associated with a usage of at least one application of the set of applications; and
output the generated set of instructions.

17. The computer system of claim 11, wherein the program instructions further cause the processor set to:
convert the first set of instructional interactions into a first textual description, wherein the first textual description is in a text format; and
apply the language model to the first textual description, the first environment data, and the second environment data.

18. The computer system of claim 11, wherein the first environment data comprises at least one of identifier data associated with the first user device, operating system data associated with the first user device, or application data associated with the first user device.

19. The computer system of claim 11, wherein the program instructions further cause the processor set to generate the first set of instructional interactions and the second set of instructional interactions in a multimodal format, and wherein the first set of instructional interactions and the second set of instructional interactions comprise at least one of one or more textual descriptions, one or more audio instructions, and one or more visual cues.

20. A computer program product for generation of instructional interactions in a virtual session, the computer program product comprising:
one or more computer-readable storage media; and
program instructions stored on the one or more computer-readable storage media to perform operations comprising:
receiving first environment data associated with a first user device and second environment data associated with a second user device;
analyzing the first environment data and the second environment data;
determining the first environment data is different from the second environment data based on the analysis of the first environment data and the second environment data;
detecting a first set of instructional interactions associated with at least one of the first user device or a first entity based on the determination of the first environment data being different from the second environment data, wherein the first entity is associated with the first user device;
applying a language model on the first set of instructional interactions, the first environment data, and the second environment data based on the detection of the first set of instructional interactions;
generating a second set of instructional interactions associated with at least one of the second user device or a second entity based on the application of the language model on the first set of instructional interactions, the first environment data, and the second environment data, wherein the second entity is associated with the second user device; and
outputting the generated second set of instructional interactions.
